(19) United States
(12) Patent Application Publication
(10) Pub. No.: US 2019/0168585 A1
(43) Pub. Date: Jun. 6, 2019

(54) AUTOMOBILE WINDOW SCREEN

(71) Applicant: MARIA CALLAGHAN, New York, NY (US)

(72) Inventor: MARIA CALLAGHAN, New York, NY (US)

(21) Appl. No.: 16/122,784

(22) Filed: Sep. 5, 2018

Related U.S. Application Data
(60) Provisional application No. 62/554,316, filed on Sep. 5, 2017.

(51) Int. Cl. B60J 1/20; B60J 1/16

(52) U.S. Cl. CPC B60J 1/2011; E06B 9/52; B60J 1/16

(57) ABSTRACT

The window ventilation system is sized for a variety of automobile windows, and provides fresh air to the vehicle. The ventilation unit's top and sides are made to slide into the door's window slot, and the bottom of the unit has a “U” shaped slot for the window to slide into. There are handles to assist with screen placement, that also double as safety bars to prevent screen from being sucked out of window. The window ventilation unit is sized such as to allow for the maximum amount of air flow possible by extending over more than one-half of the total glass window area, i.e., such that it is larger than the area of the glass window used to hold the unit in place.

### BACKGROUND OF THE INVENTION

It is well known to insert a screen into an open window of an automobile on hot days on hot days to provide ventilation and to exclude insects. However, a common problem is that the screen is often easily bent or pulled out of the window as a result of the Bernoulli effect of a car moving at highway speeds e.g. 60 miles per hour or more. The problem has been considered from various points of view such as having a rigid framework that inserts into the sides and top of the window opening into which the glass normally fits; this however has been found to be not fully effective at highway speeds. Specifically, the pressure differential between the exterior of the automobile and the interior of the automobile resulting from the high-speed movement of the automobile causes the screen to be pulled out of the window frame and out onto the highway. It has been attempted to resolve this issue by having a rigid frame that fits into the sides of the window normally filled by the glass when the window is fully closed. However, as stated, this has not been fully effective and the use of such devices has been reduced substantially in extremely warm conditions such as in the southwestern United States even in desert areas where air conditioning has been used as a substitute for the fresh air flowing from a screen window. However, with the need for lower fuel usage, to reduce pollution, the use of air conditioning has been discouraged where the effect of it is to reduce an automobile's gasoline mileage.

A further problem of the prior art is that the relatively thin strands of wire used in forming the screen mesh to keep out mosquitoes is too easily punctured, for example by vandals or just by the effect of the pressure differential described above.

U.S. Pat. No. 6,367,536, to St. Louis, shows a soft screen with several components for attachment.

U.S. Pat. No. 5,524,694 to Arapis, shows a protective screen for a vehicle window with elastic straps which loop around the bottom of the door and a plastic sheet there between. The plastic sheet protects the occupants from thrown debris such as bricks and block. Such a device would not be practical for providing ventilation there through due to its construction and intended use nor would the rigid structural plastic material readily allow the screen apparatus to be folded for storage without mechanical damage.

U.S. Pat. No. 4,139,233 to Bott discloses a screen for the window at the top of a vehicle door attached about the mirror and armrest similar, in some respects, to the previous mentioned design. This design also employs magnets for securing the screen to the vehicle door. A disadvantage of this design is that it is not readily usable, without a large modification, on another vehicle and is limited in portability.

U.S. Pat. No. 5,713,624 to Tower discloses a restraining net for a car window with mesh and attaching devices for use with a vehicle door that is also similar to the previous designs with similar disadvantages.

U.S. Pat. No. 3,960,195 to Marchbanks shows a ventilated screen for motor vehicle passenger compartment window openings. The design employs a zipper and is installed between the weather stripping and the vehicle window body structure. A disadvantage is that the design is difficult to install and cannot be readily transported for use on another vehicle nor can it be readily stored in a compact manner when not needed. Accordingly, a novel design for such window screens for automobiles is now being provided; this new invention results in a significant improvement in both maintaining the screen in place and preventing puncture of the screen mesh.

### SUMMARY OF THE INVENTION

The present invention improves on prior art devices in terms of screen material, and protection from the pressure effects damaging to the screens. The screen of this invention, interchangeable between cars or trucks with a similar sized window frame, the material forming the frame is a rigid metal material, which reduces the likelihood of puncture. Preferably, there can also be extending across the screen, vertically, a few rigid strands to strengthen the mesh material.

The screen is surrounded at its outer edge by a rigid frame of lightweight metal material, but thin enough to fit within the window glass frame grooves. Unlike conventional wire mesh, the mesh of this preferred embodiment of this invention, by virtue of the somewhat larger diameter and rigid additional vertical strands, is also able to provide protection from punctures, and enhanced protection from the glare of the sun, as well. The material provides enhanced protection from insects and debris without compromising visibility or ventilation. The top and side edges of this screen unit are mounted within the window grooves of the car door frame; however, in a preferred embodiment the lower edge of the screen is itself slotted to fit over the top of the window glass. In a preferred embodiment the lower surface has a somewhat greater width than the side and top edges and forms a slot of at least 0.5 inch but preferably not more than 1 inch, extending over the top of the glass portion of the automobile window.

When not in use, the screen can be easily removed by letting down the glass window while simultaneously holding the handles 6 from the inside of the window, and moving the rearmost frame portion 24 forwardly, away from the window frame slot 30. Thus, passengers can quickly insert the screen into a window opening, to provide protected ventilation, and can slide the screen out of the open window, when it is not needed.

As a major element of this invention, fingers, or handles, are provided, extending from the upper edge of the screen frame over the internal edge of the automobile door, so as to prevent outward movement of the screen, even when the automobile is moving at above 60 miles per hour. The fingers can be substantially rigid or have a high modulus of elasticity, so as to be sufficiently strong to protect against the screen flying outwardly when the vehicle is moving at highway speeds. The fingers can be formed of a strong polymer material, especially a fiber reinforced polymer, or of metal.

These fingers also assist with screen placement as handles, in addition to acting as safety bars to prevent the screen from being sucked out of the open glass window.

It is noted that in addition to the several advantages described above, the screen of the present invention allows full visibility outwardly for passengers.

These and other objects and advantages of the present invention will be fully apparent from the following detailed description, when taken in connection with the annexed drawings.

### GENERAL DESCRIPTION OF DRAWINGS

FIG. 1 is a diagram of a preferred embodiment of the present invention showing it fully installed in an automobile rear window from the interior of the automobile;

FIG. 2 is another preferred embodiment of the present invention showing it placed within the window frame but not as yet fully installed;

FIG. 3 is a cross-sectional view, taken along line B-B, of the preferred embodiment of FIG. 1, showing the frames at the top and bottom of the mesh screen;

FIG. 4 is an interior isometric view as fitted into an automotive window of a further preferred embodiment of the present invention;

FIG. 5 is an external isometric view of the preferred embodiment of FIG. 4;

FIG. 6 is a partial cutaway view showing the locking mechanism for holding the slidable window frame in the unextended position based upon the size of the window frame;

FIG. 7 is an isometric cross-sectional view taken along lines A-A of FIG. 4 showing the support for a window insert and the manner in which the screen mesh is held within the frame;

FIG. 8 is an extended interior view of the preferred embodiment of FIG. 4 showing the frame in its fully extended position; and

FIG. 9 is a partial cutaway interior view showing the mechanism locking the frame into the fully extended position, from FIG. 8.

### DETAILED DESCRIPTION OF THE INVENTION

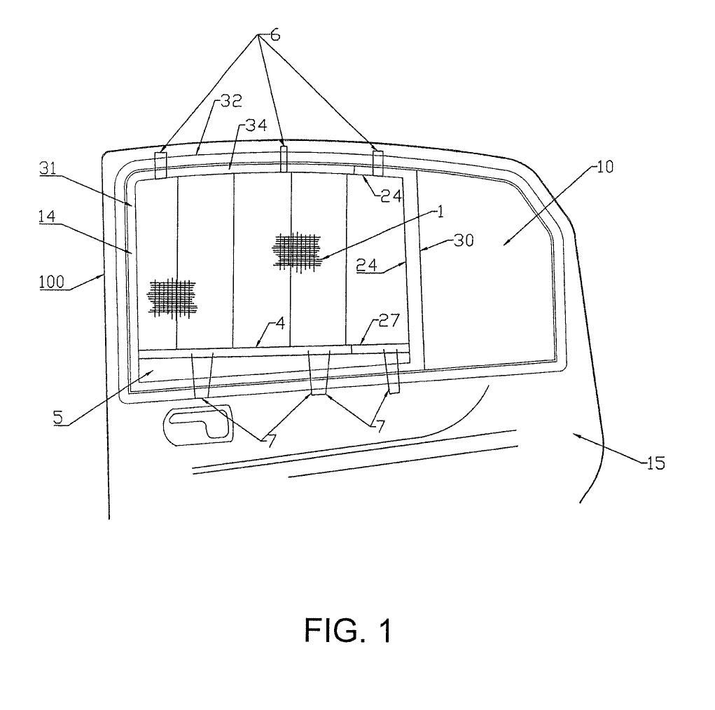

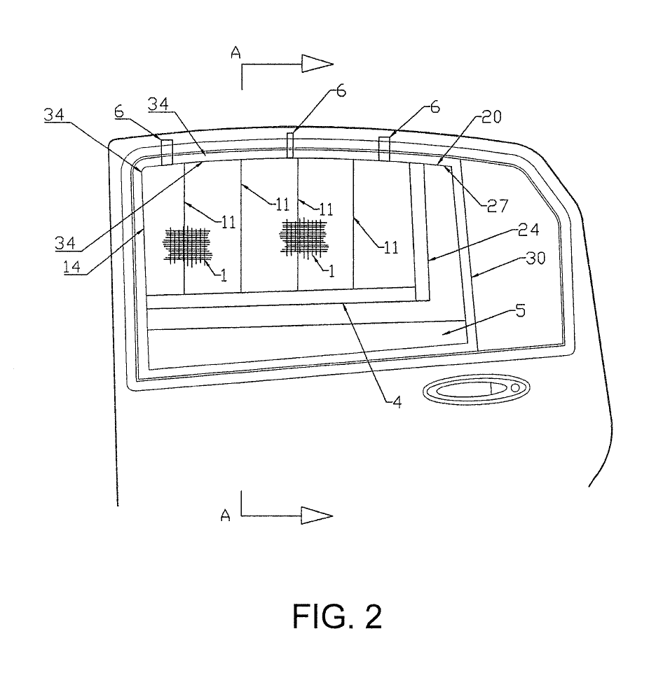

Referring to the drawings of FIGS. 1 and 2, they depict views of a preferred automobile window screen of the present invention. The screen is shown from the inside of the rear door of a modern automobile where the rear window includes two sections, a rearmost section 10 which is generally immovable and a square forward section 100, which includes a glass window 5, which moves up and down to open or close the window 1 of FIG. 1. As shown, the glass window 5 is held between the window side frame 30, 31 slots to guide the glass window as it moves up or down. The glass window fits into the top slot 32 of the window frame when it is fully closed.

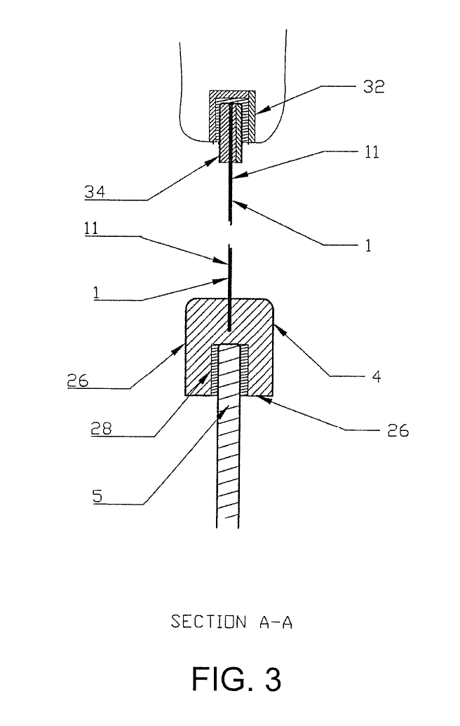

The frame 24, 34, 44, and 45 of the window screen 1 fits into the window slots at the top 34 and two side slots 30, 31 of the car window. The bottom portion 44 of the screen frame forms a U-shaped slot (as shown in the cross-sectional view of FIG. 3), into which the upper edge of the glass window 35 can be inserted so that all four sides 24, 34, 44, and 45 of the window screen frame are supported in the automobile door. The fine mesh screen 5, has approximately the same mesh size as found in a home window screen, and is intended to allow for air to flow freely through the automobile window while preventing the entry of insects or grit from the road.

The fine mesh screen 5 is formed usually of thin metal or plastic wire. In the preferred embodiment shown in the drawings, there are also provided heavier and stronger wire lengths 41 extending from the bottom frame 44 to the top frame 34, and are either woven through the mesh of the window screen 5, or along the outside of the mesh; these stronger wires 41 are intended to strengthen the screen and prevent the screen from being easily torn, either intentionally or accidentally. The thin wire mesh 5 between the stronger wires 41 can be bent, as explained below, when the rear screen frame portion 24, is slid forwardly.

To further strengthen the screen, the frame, especially the top and bottom portions of the frame, are made stronger and more rigid. This, however, also makes it more difficult to fit the screen tightly into the automobile window frame, as the more rigid members cannot be easily bent. In another preferred embodiment of this invention the screen frame can be readily adjusted along the length of the upper and lower frames, so that it will fit from side to side into the window opening; the sides of the screen frame can then be extended to fit snugly within the side slots of the car window frame. In the preferred embodiment shown in the FIGS. 1-3, the bottom and top portions 44, 24 of the frame have a telescoping fit, where the rearmost side frame portion is secured to two short side lengths 26 that, in this case, fit within the lower and upper frame pieces, as shown in FIGS. 2 and 3, and can slide back and forth between a fully extended position and a nonextended position. In the nonextended position, as shown in FIG. 2, the screen mesh between the rear frame portion 30 and the rearmost heavy wire 11, can fold, or bend to allow for such extension.

The bottom portion 4 of the frame is in the shape of an inverted U, as shown in FIG. 3, so as to form a slot that permits the glass window to be inserted and further support the mesh screen.

In order to prevent loss of the screen due to pressure differences between the interior and the exterior of the automobile; when the automobile is moving along at highway speeds, for example at more than 60 miles per hour, there is generated a pressure differential that can cause the screen to be pushed outwardly. To counteract the effect of that pressure differential, there are provided in accordance with the present invention, fingers, or clips 20, secured to the upper portion of the screen frame member 34. These clips extend from the frame member 34 and press against the interior wall of the automobile. These clips preferably have a padded or other type of soft surface so as to avoid any damage, such as scratching, to the interior of the car. As shown in FIG. 1, there can be a second set of optional clips 27, extending from the bottom frame portion of the screen and extending over the glass and pressing against the lower frame of the car window, to add additional support to prevent outward movement of the screen regardless of the speed at which the car may be moving. The second set of clips 27 should also have padding or other soft surface to prevent damage to the interior of the automobile.

The clips or fingers 20, 27 are preferably formed of a metal or a reinforced plastic having a Young's Modulus of at least 10 Mpsi, and preferably of at least 40 Mpsi.

Referring to the drawing of FIG. 2, the same preferred embodiment is shown but in this case the screen is not as yet fully embedded within the window of the automobile. The glass window 55 of the car is kept at a lower level so it is not pushed up into the slot in the lower frame portion 44 of the screen, and the side frame 30, in this case the rearward side (although it would be equally feasible to have the movable portion at the forward edge of the screen frame); once the screen is held within the open car window frame, the side of the screen frame is moved slightly rearwardly so as to insert the screen frame into the frame of the window; once the top and one edge of the screen is held in place, the rearward edge of the screen frame 30 can be extended rearwardly so as to fit within the rear slot of the window frame of the automobile; and the glass window can be raised so as to fit within the slot of the lower screen frame 44. This locks the screen in place in the window of the automobile.

Referring to FIG. 3, the cross-sectional view shows the screen mesh 5, the upper portion of the screen frame 34 in the auto window slot, and the window glass can then be moved upwardly to meet the bottom portion of the frame 4, so that it fits into the U-shaped slot 26. In addition, as shown in the cross-sectional view, there is the sliding portion indicated by the 27 in the upper frame and the 26 in the lower frame edge which slide within the outer frame edge to permit movement of the of rearward edge so as to render it more easily insertable into the window frame 30.

This sliding system is especially important when the frame of the screen is of a relatively strong, rigid material and is not easily bent. This permits the sliding edge of the screen frame to more easily fit within the automobile window frame and the glass moves into the U-shaped slot when the side edges are all securely within the top and side slots of the window. The cross-sectional view of FIG. 3 also shows one of the reinforcing wires 11, extending through the screen mesh 1.

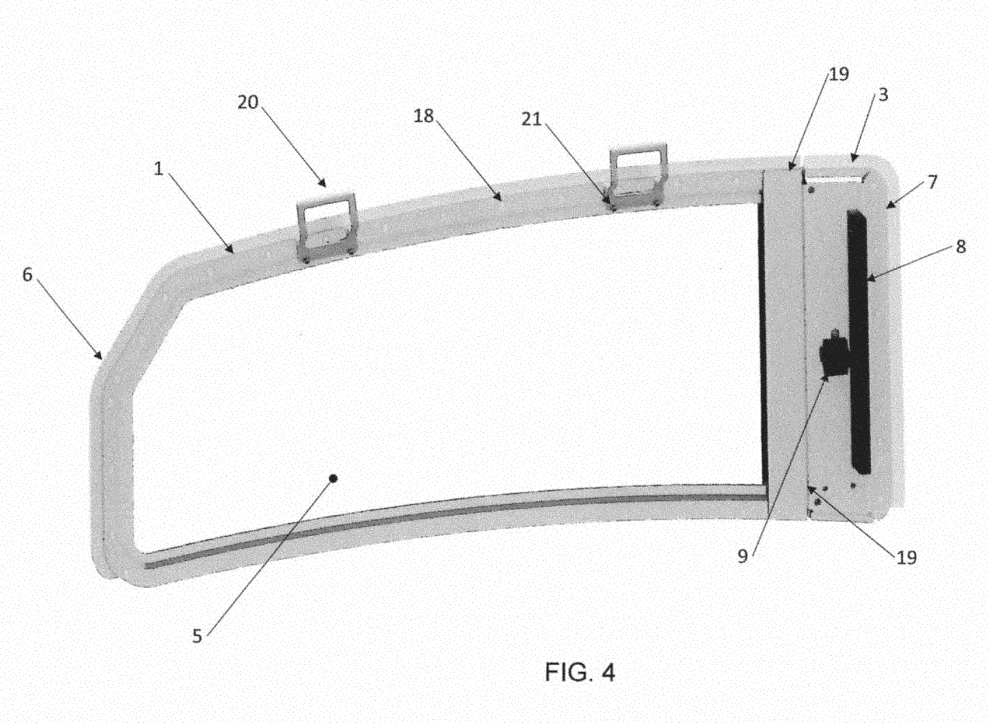

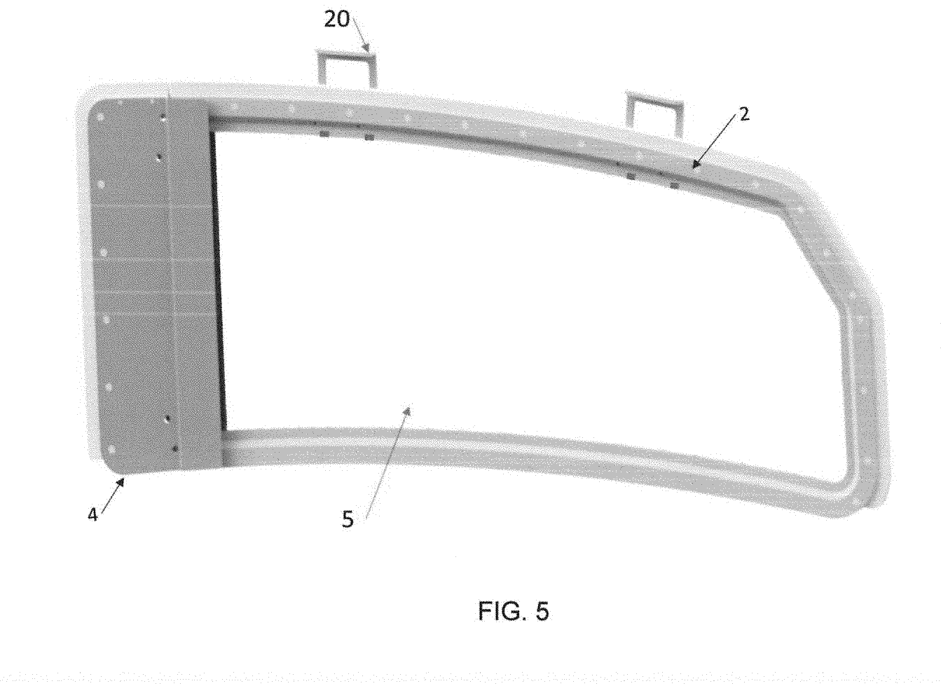

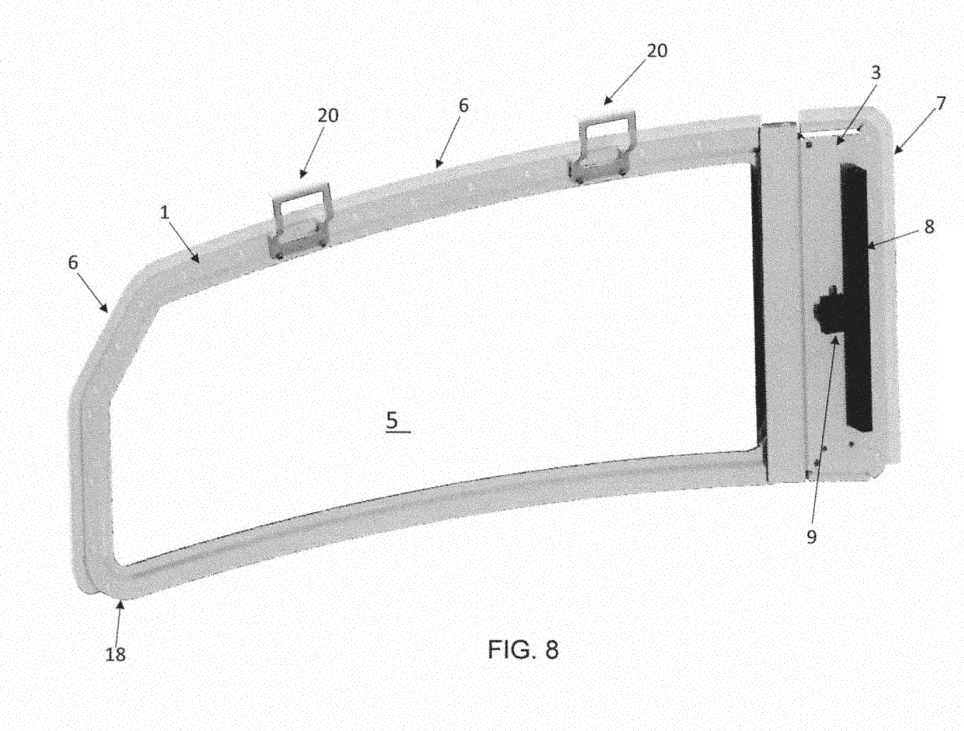

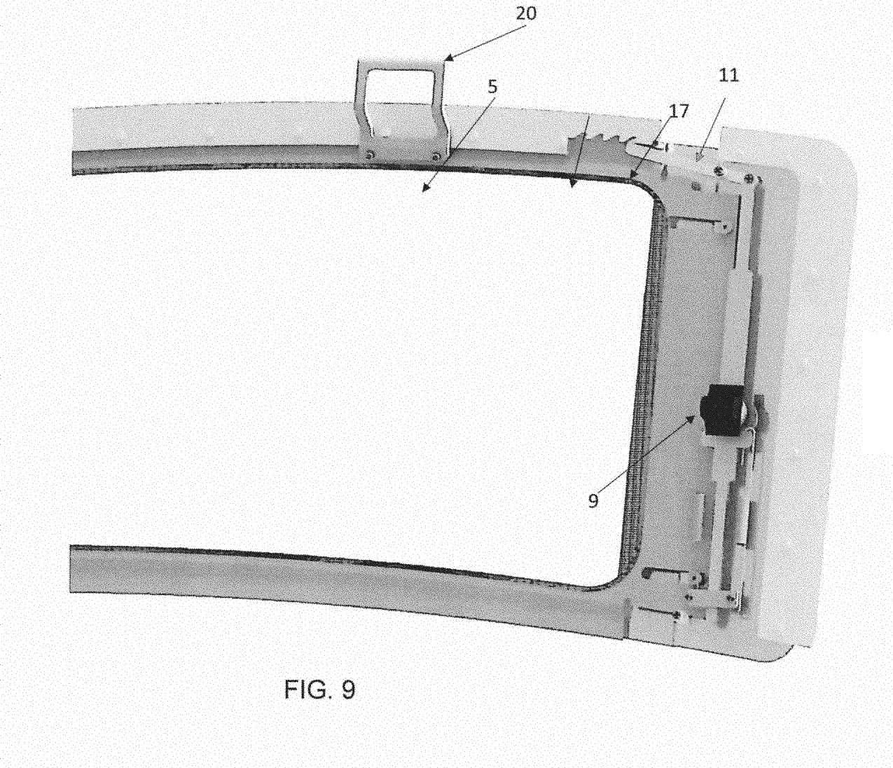

Referring to the embodiment of FIGS. 4 through 9 a more preferred embodiment provides a locking system for maintaining the sliding portion of the window in a specific position based upon, in this particular case, a lever and ratchet arrangement having specific locations along the extension of the screen. Other types of locking systems for holding the sliding sections in place can also be used within the scope of this invention.

In order to maintain a continuous closure of the window opening with the screen in an extended position, a housing spacer 17 is provided between the inner and the outer frame so as to maintain the blockage of the window space and prevent any potential insect or debris from entering the interior of the vehicle, as the screen frame is extended.

In this embodiment the frame comprises 2 portions which slide over the spacer that although maintaining the same size screen mesh ensures that the open window space is fully closed off from the outside as the frame portions are extended and thus separated.

To protect the relatively delicate weather stripping within the window slots holding the glass window in place from damage a plastic insert 6 is inserted between the interior and exterior frames 1, 2 which fit within the upper and side window slots. Alternatively, to ensure a more rigid frame, the window inserts can be formed of a rigid metal covered with a softer plastic which would be in direct contact with the weather stripping and prevent any damage from potentially sharp metal corners.

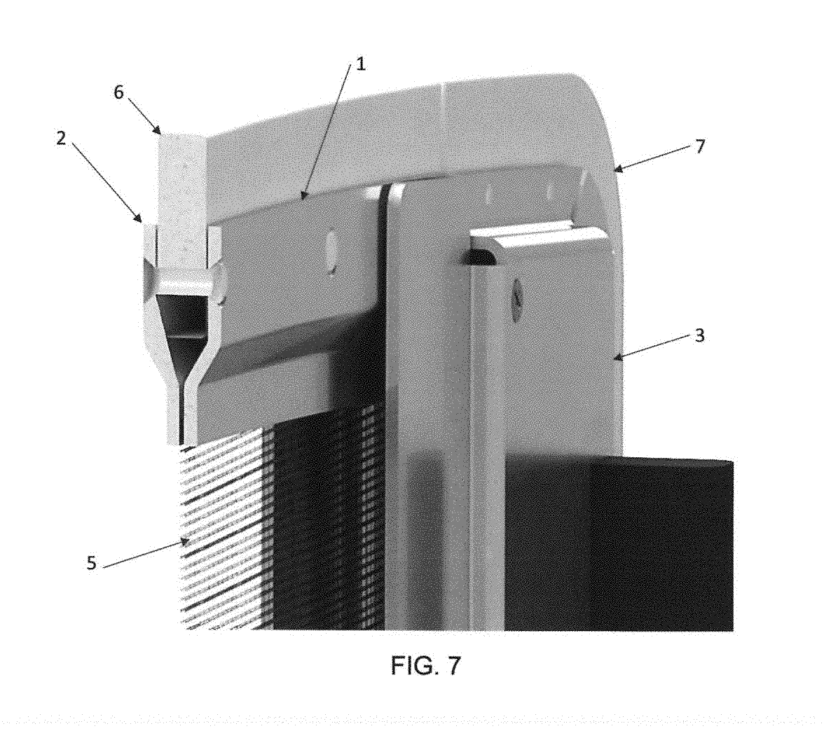

This preferred embodiment includes an internal frame 1 connected to an external frame 2, leaving a space between the 2 frames as shown in the cross-sectional view of FIG. 7. The inner and outer frames are shown as connected by rivets and the upper portions of these frames as well as the sides are bent inwardly so as to closely grip the much thinner mesh 5. As shown the mesh screen includes thinner wires forming the mesh along with spaced thicker wires, thus strengthening the mesh so as to prevent accidental or undesirable intentional breakage, and preventing entry into the interior of the vehicle.

In addition as shown in the 2 safety handles 20 connected to the inner frame 1 are each formed having 3 sides thus increasing the rigidity of each safety unit. These safety handles can be coded in a soft plastic or foam in order to prevent any damage to the interior of the automobile against which they are pressed. In addition, as stated above, a second group of such safety handles can be placed along the lower edge of the upper frame and pressed against either the glass window or extend below the glass window to the door window frame of the vehicle. They can be either solid units, as shown in FIG. 1, or in the shape of handles as in the upper portion of the window frames.

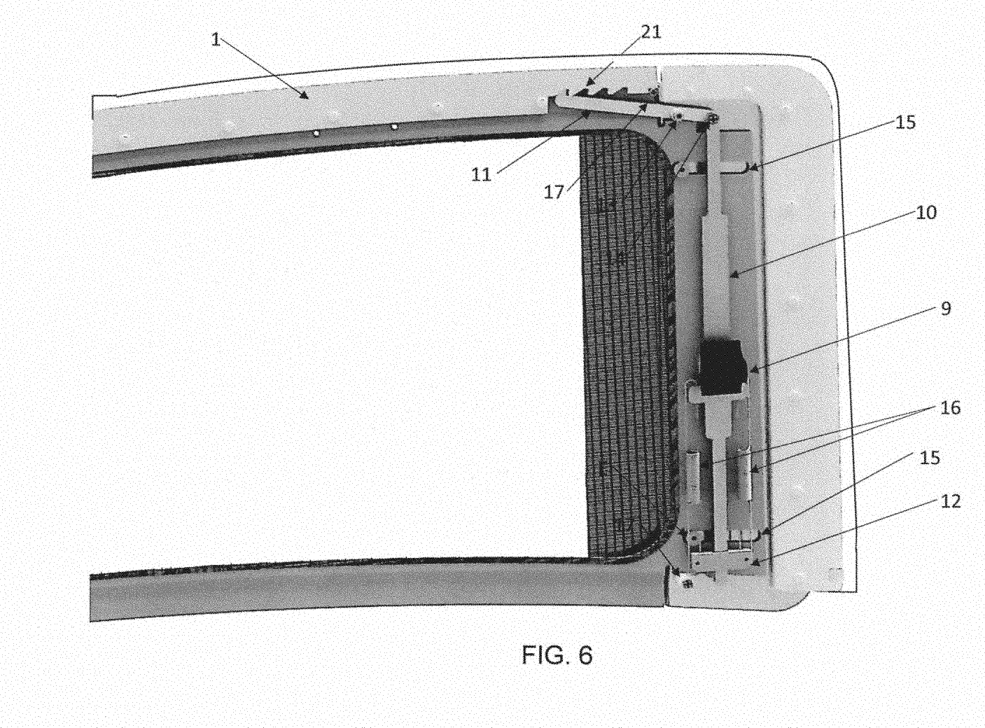

When it is desired to change the extension of the frame to either further extend or reduce an extension, the push switch handle 9 is pushed upwardly and as shown in the breakaway view of FIG. 6, this results in the releasing of the locking lever 11 from the ratchet groove 21, permitting the side frame 7 to be pulled outwardly; in this most preferred embodiment by holding the handle 8 and pushing rearwardly or forwardly as desired. When the correct size or length has been reached, such that the right edge 7 of the frame is extended into the side opening of the window frame, the push switch 9 can be released and the bias spring 16 will lock the lever 11 into the closest ratchet groove 21, thus locking the sliding portion in place. As shown in FIG. 6, the slider switch 9 is biased to the closed position.

As shown in the cross-sectional view of FIG. 3 the open slot between the inner and outer frames 1, 2, which is not filled who with a window insert 6 along the lower frame edge extends over and grips the top of the window glass when it is raised slightly above the vehicle window frame the interior of the slot between the inner and outer frames can be lined with a soft polymer or foamed material so as to avoid any scratching or other damage to the window glass as the window frame inserts 6 have substantially the same thickness as the window glass, the lower frame opening can fit around the glass directly or by having a slightly wider opening permits the application of the polymer to protect the glass from damage. The thin polymer coating, whether rubber or nonelastic polymer helps to maintain the position of the frame and the window by increasing friction in addition to protecting the glass. Paragraph the screen mesh is secured between the inner and the outer frame members as shown in the cross-sections of FIG. 3 and FIG. 7.

As is shown in the drawings specifically FIGS. 3 and 7, as well as in FIG. 6, the right side of the frame which is the sliding member, forms the rear edge of the screen frame that fits into the rearward side edge of the window frame of the vehicle. The spacer 15 is a plate that extends between the major portion of the frame and the rear frame edge that closes off the opening of the window when the rear frame is extended rearwardly. Just as the mainframe includes an inner and outer frame 1, 2 the rear, movable frame also includes, as separate pieces, an inner and outer frame 1a and 2a, between which the main inner and outer frames 1,2 can slide.

What is claimed is:

1. In a fine mesh screen for open automobile windows, the fine mesh screen comprising a frame having an upper, lower and two side edges being intended to be inserted into the glass window slots of the automobile window, and the lower frame edge forming a u-shaped slot opening downwardly and intended to slip over and around an upper portion of the glass window to thereby lock the frame in place; the improvement comprising a plurality of fingers extending from the upper edge of the screen frame upwardly and in firm contact with the interior of the molding surrounding the automobile window, the fingers can be substantially rigid or have a high modulus of elasticity.

2. In the fine mesh screen for open automobile windows of claim 1, the further improvement comprising the frame for the fine mesh screen being substantially rigid and having telescoping top and bottom edges to allow for changing the width of the screen in order to more easily fit within the automobile window slots.

3. In the fine mesh screen for open automobile windows of claim 1, the further improvement comprising a plurality of lengths of heavier wire extending from the lower frame edge to the upper frame edge and spaced along the width of the mesh screen, the heavier wire being woven through the fine mesh or being located on the external side of the fine mesh screen.

4. In the fine mesh screen for open automobile windows of claim 1, the further improvement comprising fingers extending from the lower edge of the screen upper frame portion, upwardly and in firm contact with the interior molding surrounding the open automobile window.

5. In a fine mesh screen for open automobile windows, the fine mesh screen comprising a frame having an upper lower and side edges, the upper and two side edges intended to be inserted into the glass window slots of the automobile window and the lower frame edge forming a u-shaped slot opening downwardly and intended to slip over and around an upper portion of the glass window to thereby lock the frame in place; the improvements comprising a safety grip extending from the upper edge of the screen frame upwardly and in firm contact with the interior of the molding surrounding the automobile window, a second safety grip extending from the lower edge of the screen frame downwardly and in firm contact with the interior molding surrounding the automobile window, the fingers can be formed of a rigid material or a material having a high modulus of elasticity; the frame for the fine mesh screen being substantially rigid and having telescoping top and bottom edges to allow for changing the width of the screen in order to more easily fit within the automobile window slots, and a plurality of lengths of heavier wire extending from the lower frame edge to the upper frame edge and spaced along the width of the mesh screen, the heavier wire being woven through the fine mesh or being located on the external side of the fine mesh screen.

6. The fine mesh screen for open automobile windows of claim 5, further comprising a sliding rear frame for adjusting to various size vehicle windows and a locking system for maintaining the rear frame in a set position so as to fill the window opening and not permit the entry of any debris or insects.
